(19) United States
(12) Patent Application Publication
(10) Pub. No.: US 2025/0354912 A1
(43) Pub. Date: Nov. 20, 2025

(54) TEST SYSTEM WITH A VACUUMISABLE TEST CHAMBER

(71) Applicant: Carl Zeiss SMT GmbH, Oberkochen (DE)

(72) Inventor: Markus KAESTNER, Oberkochen (DE)

(21) Appl. No.: 19/286,956

(22) Filed: Jul. 31, 2025

Related U.S. Application Data
(63) Continuation of application No. PCT/EP2024/052572, filed on Feb. 2, 2024.

(30) Foreign Application Priority Data
Feb. 2, 2023 (DE) 10 2023 200 859.9

(51) Int. Cl. G01N 17/00; G01D 11/24

(52) U.S. Cl. CPC G01N 17/002; G01D 11/245

(57) ABSTRACT

A test system (1) having a test chamber (2) for a test object, wherein the test chamber has at least one chamber wall (3) delimiting the test chamber. The test chamber is assigned a first vacuum generator (12) generating a vacuum in the test chamber. The chamber wall has an opening (4) to which a sensor module (5) is assigned. The sensor module has a carrier element (6), which is arranged on the chamber wall, to close the opening. A sensor (10) is arranged on a side of the carrier element facing toward the test chamber. A negative-pressure chamber (17) assigned to the opening is formed on the side of the chamber wall facing away from the test chamber. The negative-pressure chamber is assigned a negative-pressure generator (19) generating a negative pressure in the negative-pressure chamber independently of a vacuum in the test chamber.

### CROSS-REFERENCE TO RELATED APPLICATION

This is a Continuation of International Application PCT/EP2024/052572, which has an international filing date of Feb. 2, 2024, and the disclosure of which is incorporated in its entirety into the present Continuation by reference. This Continuation also claims foreign priority under 35 U.S.C. § 119 (a)-(d) to and also incorporates by reference, in its entirety, German Patent Application DE 10 2023 200 859.9, filed Feb. 2, 2023.

### FIELD

The invention relates to a test system, in particular an optical test system, having a test chamber in which a test object can be arranged, wherein the test chamber has at least one chamber wall delimiting the test chamber, wherein the test chamber is assigned a first vacuum generator in order to generate a vacuum in the test chamber, wherein the chamber wall has at least one opening which is assigned at least one sensor module, wherein the sensor module has a carrier element, which is arranged on the chamber wall so as to close the opening, and a sensor, in particular an optical sensor, temperature sensor, pressure sensor, gas sensor or a camera-sensor, which is arranged on a side of the carrier element facing toward the test chamber.

Furthermore, the invention relates to a method for operating the above-mentioned test system.

### BACKGROUND

Optical test systems of this type are known from the prior art.

In order to test sensitive and particularly precise optically effective objects, such as lenses, lens elements, mirrors or the like, it is known to examine them in a cleanroom. For this purpose, a test chamber is provided, in which the test object can be arranged. A vacuum is then created in the test chamber with a vacuum generator, such that impurities are removed from the test chamber. This also produces a negative pressure in the test chamber, that is to say a pressure level which is lower than the ambient pressure of the test chamber. Conventional sensors, in particular camera-sensors, are not designed for use in a vacuum. In particular, in the case of conventional camera-sensors, the electronics required for the function of the camera-sensor can “outgas” in the vacuum. Outgassing in this context is in particular understood to mean that contaminating substances escape from the material of the electrical/electronic components of the sensor and can lead to contaminants being present in the test space, which in turn can lead to distorted test results. Therefore, care is generally taken to ensure that the electronics of such a sensor do not lie in the vacuum of the test chamber itself.

In order to avoid this, it is known to detach the sensor from the rest of the electronics of the sensor module and to arrange only the sensor in the test space, while arranging the remaining electronics outside the test chamber. This reduces the outgassing problems considerably. However, in the case of such a solution care must be taken to ensure that the often delicate or sensitive sensor signals which have to be guided from the sensor to the electronics are conducted through vacuum leadthroughs, as a result of which other problems can arise. Particularly in the case of high-speed images or signals, these leadthroughs cannot readily be realized and are generally associated with high costs. The signal integrity of the signals to be transmitted is also often impaired by the vacuum leadthrough.

As an alternative, the sensor itself may be used as a separating point between the test chamber and the external environment of the test chamber so that only the parts of the sensor module which are actually required in the vacuum, namely the sensor itself, are exposed to the negative pressure of the vacuum. This lessens the outgassing problems; however, forces which have a disadvantageous influence on the sensor can arise owing to the pressure difference during testing operation between the test chamber on the one hand and the external environment on the other hand. The acting forces can thus cause a deformation of the sensor, which leads to distorted measurement results. In order to avoid this, the sensor must be formed with particularly high strength, as a result of which high costs also arise. In the case of highly precise applications or measurements, even the smallest deformations of the sensor during operation cannot be tolerated. Therefore, the requirements in terms of strength are particularly high and thus also the investment needed to realize the required strength becomes correspondingly high.

### SUMMARY

Accordingly, one object of the invention is to provide a test system which at least reduces or even prevents both the outgassing problems and the problems regarding the mechanical loading of the sensor.

This and other objects are addressed by a test system as claimed. This has the advantage that the mechanical loading of the sensor is reliably reduced or avoided altogether cost-effectively and without disregarding the outgassing problems.

According to one formulation of the invention, a negative-pressure chamber assigned to the opening is formed on the side of the chamber wall facing away from the test chamber, and the negative-pressure chamber is assigned a second negative-pressure generator in order to be able to generate a negative pressure in the negative-pressure chamber independently of a vacuum in the test chamber. This thus provides that a negative pressure is also generated on the side facing away from the test chamber, said negative pressure counteracting the vacuum or negative pressure acting in the vacuum chamber during testing operation. This reduces or prevents the mechanical loading of the sensor that results from the pressure difference between the vacuum in the test chamber and the negative pressure in the negative-pressure chamber. In this case, the rest of the electronics of the sensor module are also arranged on the side of the carrier element facing away from the test chamber and thus lie in the negative-pressure chamber. In particular, the sensor has a sensor surface which is arranged on a side of the carrier element facing toward the test chamber and thus lies in the test chamber. The negative-pressure chamber is advantageously formed such that it completely surrounds or encloses the rest of the electronics of the sensor module, i.e. except for the sensor, which are advantageously arranged on the side of the carrier element facing away from the test chamber, together with the carrier element. By actuating the negative-pressure generator independently of the first vacuum generator, it is possible to set the negative pressure in the negative-pressure chamber to a desired level, as a result of which the above-mentioned advantages are achieved. Here, the negative pressure is at least set so that the pressure in the negative-pressure chamber is lower than the ambient pressure of the test system. Advantageously, the negative pressure in the negative-pressure chamber lies between the ambient pressure and the pressure in the vacuum chamber. As an alternative, the pressure in the negative-pressure chamber corresponds to the pressure in the vacuum chamber, such that mechanical loading of the sensor is precluded. It is thus possible, depending on the application or test object and the employed or used camera-sensors, for both outgassing of the electronics into the test chamber and mechanical overloading of the sensor to be prevented. Optionally, the one negative-pressure chamber is assigned to a plurality of openings in the chamber wall, each opening being assigned at least one respective sensor or sensor module. As an alternative, a plurality of openings in the chamber wall are assigned a respective negative-pressure chamber, each negative-pressure chamber being assigned a dedicated negative-pressure generator or the negative-pressure chambers being assigned a common negative-pressure generator. In the last-mentioned case, the negative-pressure chambers are in particular connected to one another in order to be able to establish the desired pressure in the negative-pressure chambers with the common negative-pressure generator.

According to an advantageous development, the negative-pressure chamber is formed by a covering element placed onto the chamber wall or the carrier element. In this case, the covering element is formed such that it firstly forms together with the chamber wall and/or the carrier element the negative-pressure chamber, that is to say a three-dimensional space with a determined volume greater than zero, and secondly is suitable for generating a vacuum between the covering element on the one hand and the carrier element and/or the chamber wall with sensor module on the other hand, that is to say in the negative-pressure chamber or in the volume. The covering element may be manufactured in different sizes and thicknesses and from different materials. Thus, the covering element is designed, for example, as a suction hood, in particular as a suction bell, or as a tub-like or cup-like placement element. A matching covering element thus easily makes it possible for a negative-pressure chamber that matches the sensor module or sensor to be provided on the carrier element or on the chamber wall. In this case, the negative-pressure chamber is formed between the covering element on the one hand and the chamber wall of the test chamber and/or the carrier element on the other hand. The covering element is thus advantageously designed to be placed onto the chamber wall or onto the carrier element and to provide sealing closing therewith. The covering element has, for example, a rectangular longitudinal section, a cylindrical shape, a polygonal, round, in particular circular round or oval, cross section and/or a bell shape.

Advantageously, the negative-pressure generator is a second vacuum generator. The second vacuum generator is, for example, the same model which is also used for the first vacuum generator. Optionally, it is a model with lower power, since complete equalization of the pressure difference between the test chamber and the negative-pressure chamber is not necessarily required.

Furthermore, it is advantageously provided that the first and/or the second vacuum generator are/is designed as a suction device, in particular as a pre-vacuum pump, single-stage vacuum pump or turbo pump. This permits conventional vacuum generators to be used, which can be inexpensively procured and can permanently maintain a vacuum and/or a negative pressure in a reliable manner.

According to another advantageous development, the first vacuum generator and the negative-pressure generator are formed such that, and/or set by a regulating device such that at least during testing operation the pressure in the test chamber is lower than in the negative-pressure chamber. This ensures that a force resulting from the pressure difference is applied to the sensor, if anything, in the direction of the test chamber. A deformation or loading of the camera-sensor in the direction of the test chamber is less critical than the other way round. The advantageous design ensures that the reverse loading situation cannot occur.

Furthermore, it is advantageously provided that a first pressure sensor is arranged in the test chamber and/or a second pressure sensor is arranged in the negative-pressure chamber. With the pressure sensors, the pressure in the test chamber and in the negative-pressure chamber can be set precisely and in particular a desired pressure difference between the test chamber and the negative-pressure chamber can be set to a desired value or be completely equalized. Optionally, a third pressure sensor is also provided outside the test system, in particular on an outer side of the test chamber that does not lie within the negative-pressure chamber, said third pressure sensor being used to measure the ambient pressure. Optionally, the first and the second pressure sensor are designed as a differential pressure sensor.

In particular, it is advantageous to arrange a differential pressure sensor in the opening. This differential pressure sensor interacts both with the test chamber and with the negative-pressure chamber in order to measure the differential pressure between the test chamber and the negative-pressure chamber. Hereby, the pressure ratio between the two chambers can be measured and regulated in a particularly advantageous manner.

According to yet another advantageous development, it is provided that the vacuum generator is connected to the test chamber by a first connecting element and/or the negative-pressure generator is connected to the negative-pressure chamber by a second connecting element. As a result of the first and/or the second connecting element, an advantageous arrangement of the vacuum generator and/or of the negative-pressure generator outside or within the test chamber and the negative-pressure chamber, respectively, is possible. As a result, optimal space utilization and positioning are ensured.

In particular, for this purpose the respective connecting element is designed as a hose, as a tube or as a flange.

Advantageously, the carrier element has a circular, polygonal, in particular triangular or quadrangular, symmetrical or asymmetrical outer contour. The circular outer contour ensures an advantageous pressure distribution for the carrier element during testing operation on the chamber wall. In particular, the outer edge of the carrier element bears against the chamber wall flatly or via a flange, such that the carrier element is form-fittingly prevented from being sucked into the test chamber by the negative pressure prevailing therein. In particular, for this purpose the chamber wall has an in particular circular-ring-like bearing region which corresponds to the edge region and within which the opening in which the sensor lies is formed.

Advantageously, the carrier element has an in particular ring-like, preferably circular-ring-like, flange on which the covering element can be arranged or is arranged in a sealing manner. As a result, the covering element interacts directly with the carrier element, which then bears against the chamber wall in particular in a sealing manner, such that the carrier element lies between the covering element and the chamber wall. As an alternative, the covering element bears directly against the chamber wall.

Furthermore, it is advantageous to provide a fastener for fastening the covering element to the carrier element or to the chamber wall. This fastener can be arranged on the carrier element or the chamber wall on the one hand and/or on the covering element on the other hand.

This enables, in particular, form-fitting fastening of the covering element to the carrier element or chamber wall. As a result, simple exchangeability of the covering element for adaptation to different boundary conditions is in particular also ensured.

The method associated with the invention is distinguished in that, for the test operation, the vacuum generator and the negative-pressure generator are actuated such that in the negative-pressure chamber a negative pressure is set which is smaller than an ambient pressure and at most as small as the pressure in the test chamber. In the present case, the ambient pressure is understood to mean the air pressure in the nearest, in particular immediate, environment of the test system or of the pressure chamber and of the negative-pressure chamber outside the negative-pressure chamber and the test chamber, which will also be referred to as atmospheric pressure. This ensures that the sensor is exposed to a differential pressure which can only exert on the sensor a force that acts from the negative-pressure chamber in the direction of the test chamber. If the pressure in the negative-pressure chamber is set so that it corresponds to the pressure in the vacuum chamber, the camera-sensor is not loaded mechanically by the pressure difference or by the pressure difference that is then missing. This results in the advantages already mentioned above. Advantageously, the current pressure in the test chamber and in the negative-pressure chamber is monitored in order to set or adjust a predetermined pressure difference between the test chamber and the negative-pressure chamber. For this purpose, use is in particular made of the above-mentioned regulating device which is designed, for example, as a control device, circuit or microprocessor.

Further advantages and advantageous features and combinations of features are evident from the foregoing and from the claims. Aspects of the invention will be explained in greater detail below with reference to the drawings. In this respect:

### BRIEF DESCRIPTION OF THE DRAWINGS

FIG. 1 shows an advantageous test system in a simplified sectional illustration,

FIG. 2 shows a carrier element of the test system in a perspective illustration, and

FIG. 3 shows a covering element of the test system in a simplified perspective illustration.

### DETAILED DESCRIPTION

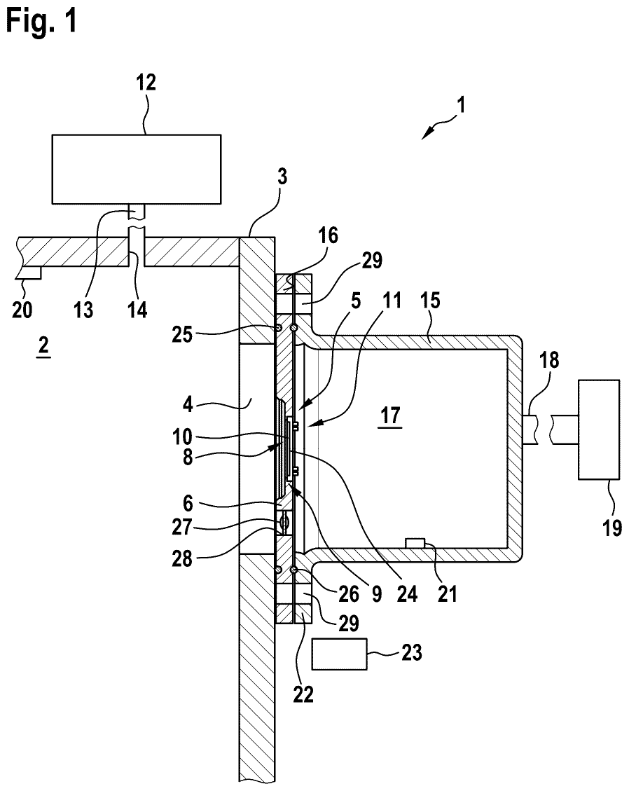

FIG. 1 shows, in a simplified sectional illustration, an advantageous test system 1 which according to the present exemplary embodiment is designed to carry out an optical test operation. To this end, the test system 1 has a test chamber 2 which is delimited by a chamber wall 3. In particular, the test chamber 2 is formed such that a vacuum can be generated in it. To this end, the test chamber 2 has a substantially closed chamber wall 3, and also a cover and a base which are not shown in FIG. 1. The chamber wall 3 is open only in certain regions, in particular in order to provide a closable opening through which a test object can be inserted into the test chamber 2 (not shown in figure). Furthermore, the chamber wall 3 has an opening 4 which is assigned a sensor module 5 with a sensor 10 for testing, in particular for measuring, the test object positioned in the test chamber.

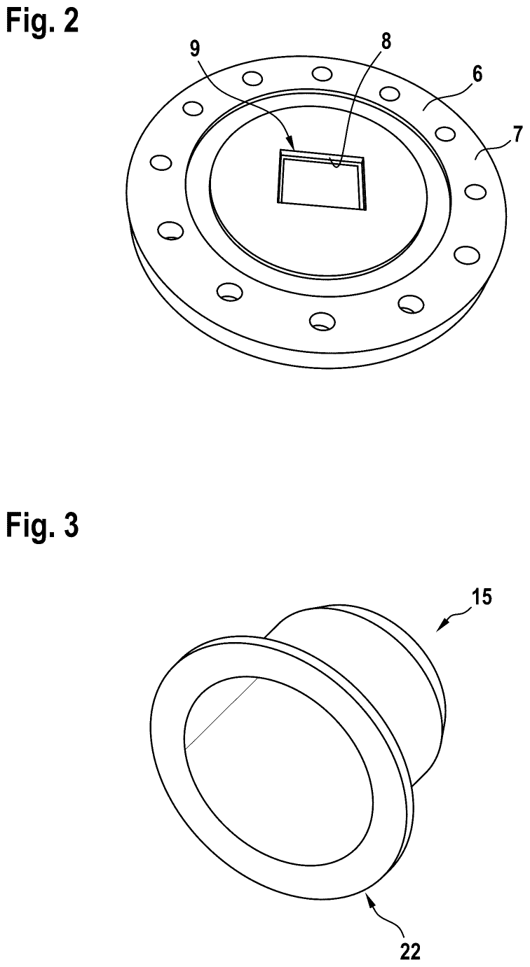

The sensor module 5 has a carrier element 6, as is shown by example in FIG. 2 in a perspective illustration. According to the present exemplary embodiment, the carrier element 6 is of circular design and has at its outer edge a flange 7 and in the middle a cutout 8 which is rectangular in the present embodiment. The flange 7 is thus of ring-like, in the present case circular-ring-like, design with a circular outer contour. The flange 7 is furthermore designed to rest flat on the chamber wall 3 on the side facing away from the test chamber 2. According to the present exemplary embodiment, the cutout 8 is provided with a step 9, such that the sensor 10 can be arranged or is arranged, in particular with the aid of a carrier 24, on the step 9 in the cutout 8 and thus in the opening 4, as shown by example in FIG. 1. Advantageously, an in particular elastically deformable sealing element 25, preferably in the form of an O-ring or another vacuum seal, is arranged between the flange 7 and the chamber wall 3.

According to the present exemplary embodiment, the sensor 10 is designed as a camera-sensor, which lies in particular in the cutout 8 and is arranged or oriented in the direction of the test chamber 2 on the carrier element 6, in order to record the test object positioned in the test chamber 2. Electronics 11 which are designed to actuate the sensor 10 and to record and optionally to pre-process the signals recorded by the sensor 10 are arranged on the side of the carrier element 6 facing away from the test chamber 2. The sensor 10 is inset at the edge in a sealing manner into the carrier element 6, such that the sensor 10, once inserted in the opening 4, completely closes off the cutout 8 and the opening 4 at the edge and/or at the end side, thereby closing the chamber wall 3 at this point in a sealing manner.

The test chamber 2 is furthermore assigned a vacuum generator 12 in the form of a suction device, which is optionally connected to the test chamber 2 by a connecting element 13, in particular a tube.

The test system 1 furthermore has a covering element 15. As shown by example in FIG. 1, the covering element 15 is in longitudinal section at least substantially of cup-like or U-shaped design with an in particular circular cross section. The open end of the covering element 15 points toward the chamber wall 3 and the free end side 16 thereof bears against the flange 7 of the carrier element 6 in a sealing manner, in particular with interposition of a further, in particular elastically deformable, sealing element 26, for example in the form of an O-ring. As a result, the covering element 15 forms together with the chamber wall 3 on the side facing away from the test chamber 2 a negative-pressure chamber 17, in which the electronics 11 lie. To this end, the covering element 15 is arranged on the chamber wall 3 so that it covers or encompasses the opening 4 and the sensor module 5 arranged in or at the opening 4.

The covering element 15 is connected to a second negative-pressure generator 19, which is advantageously also designed as a suction device, for example by a connecting element 18 in the form of a tube.

The actuation of the vacuum generator 12 makes it possible to generate a negative pressure in the test chamber 2. Preferably, a first pressure sensor 20 which monitors the pressure prevailing in the test chamber 2 is also arranged in the chamber.

The actuation of the negative-pressure generator 19 furthermore makes it possible to set a negative pressure in the negative-pressure chamber 17. Preferably, a second pressure sensor 21 which can be used to monitor the current negative pressure in the negative-pressure chamber 17 is also arranged in the chamber. Optionally, the pressure sensors 20, 21 form a differential pressure sensor and are arranged near or in the opening 4. Optionally, a differential pressure sensor 27 which interacts both with the test chamber 2 and with the negative-pressure chamber 17 is alternatively or additionally arranged on the carrier element 6, for example in a further cutout 28 next to the cutout 8.

One exemplary embodiment of the covering element 15 is shown by example in FIG. 3 in a perspective illustration in the exemplary design of a suction hood. Optionally, the covering element 15 is designed as a suction bell. The covering element 15 advantageously has a collar-like bearing portion 22 which is designed to bear in a sealing manner on the chamber wall 3, in particular the carrier element 6, and in particular to receive the sealing element 26 in certain regions. Optionally and as shown in the figures, a plurality of screw openings 29 or openings designed differently and serving for fastening, through which fastening screws for mounting the covering element on the chamber wall can be guided, are preferably formed in the bearing portion 22. Preferably, the flange 7 and the chamber wall 3 have screw openings which correspond to the screw openings 29. For mounting, a respective fastening screw is advantageously guided through the mutually aligned screw openings and screwed in so that the respective screw opening is closed in a media-tight manner in particular with the aid of in each case at least one sealing element. The covering element 15 is advantageously of circular design in cross section, as already explained above, in order to ensure an advantageous force transmission and distribution. As an alternative, the covering element 15 is designed to rest next to the carrier element 6 directly on the chamber wall 3 in a sealing manner. Optionally, the chamber wall 3 has a bulge or a protrusion in the form of a flange or of the flange already mentioned.

A control device 23 illustrated by example in FIG. 1 is designed to record the measured values from the sensors 20, 21 and to actuate the vacuum generator 12 and the negative-pressure generator 19. To carry out a test operation, a vacuum is created in the test chamber 2 by actuation of the vacuum generator 12. This provides a vacuum in which advantageous measurement results are ensured. In addition, the negative-pressure generator 19 is actuated in order to also generate a negative pressure in the negative-pressure chamber 17, said negative pressure forming a further vacuum. The negative pressure set in the negative-pressure chamber 17 is lower than the ambient pressure of the test system 1 and is at maximum as low as the negative pressure in the test chamber 2. Accordingly, the pressure difference between the test chamber 2 and the negative-pressure chamber 17 is invariably directed towards the test chamber 2, ensuring that the sensor 10 or the camera-sensor is loaded with a force, stemming from the pressure difference, at most in the direction of the test chamber 2. As a result, optimal measurement results become achievable. Optionally, the same negative pressure is set in the test chamber 2 and in the negative-pressure chamber 17, such that the sensor 10 is not loaded mechanically during a test operation.

Due to the fact that the sensor 10 faces toward the test chamber 2 and the rest of the electronics 11 lie in the negative-pressure chamber 17, what is also achieved is that the electronics 7 can outgas only into the negative-pressure chamber 17, thereby ensuring that the purity or cleanliness of the test chamber 2 is maintained during the test operation.

This thus results in an advantageous test system 1 which, on the one hand, prevents the contamination of the test chamber 2 by outgassing effects of the electronics and also ensures reliable operation of the camera-sensor 10 through avoidance of mechanical loadings.

What is claimed is:

1. A test system comprising:
a test chamber configured to house a test object, wherein the test chamber has at least one chamber wall delimiting the test chamber,
a first vacuum generator arranged to generate a vacuum in the test chamber, wherein the chamber wall has at least one opening assigned at least one sensor module, wherein the sensor module has a carrier element arranged on the chamber wall and configured to close the opening, and
a sensor arranged on a side of the carrier element facing toward the test chamber,
a negative-pressure chamber assigned to the opening and formed on a side of the chamber wall facing away from the test chamber, and
a negative-pressure generator assigned to the negative-pressure chamber and arranged to generate a negative pressure in the negative-pressure chamber independently of a vacuum generated in the test chamber.

2. The test system as claimed in claim 1, wherein the sensor is an optical sensor, a temperature sensor, a pressure sensor, a gas sensor or a camera-sensor.

3. The test system as claimed in claim 1, wherein the negative-pressure chamber is formed by a covering element placed onto the chamber wall or onto the carrier element.

4. The test system as claimed in claim 1, wherein the negative-pressure generator is a second vacuum generator.

5. The test system as claimed in claim 1, wherein at least one of the first vacuum generator and the second vacuum generator is configured as a suction device.

6. The test system as claimed in claim 1, wherein the first vacuum generator and the negative-pressure generator are configured and/or adjusted by a regulating device such that, at least during a testing operation, the pressure in the test chamber is lower than the pressure in the negative-pressure chamber.

7. The test system as claimed in claim 1, further comprising a first pressure sensor arranged in the test chamber and/or a second pressure sensor arranged in the negative-pressure chamber.

8. The test system as claimed in claim 1, further comprising a differential pressure sensor arranged in the opening between the negative-pressure chamber and the test chamber.

9. The test system as claimed in claim 1, further comprising a first connecting element connecting the vacuum generator to the test chamber and/or a second connecting element connecting the negative-pressure generator to the negative-pressure chamber.

10. The test system as claimed in claim 9, wherein the first and/or the second connecting element is configured as a hose, as a tube or as a flange.

11. The test system as claimed in claim 1, wherein the carrier element has a circular, polygonal, symmetrical or asymmetrical outer contour.

12. The test system as claimed in claim 1, wherein the carrier element has a flange configured to receive the covering element or to receive the covering in a sealing manner.

13. The test system as claimed in claim 1, further comprising a fastener connecting the covering element to the carrier element or to the chamber wall, wherein the fastener is arranged on the carrier element or the chamber wall on the one hand and/or on the covering element on the other hand.

14. A method for operating a test system as claimed in claim 1, comprising, in a test operation, actuating the vacuum generator and the negative-pressure generator such that, in the negative-pressure chamber a negative pressure is set to be smaller than an ambient pressure and no smaller than the pressure in the test chamber.
